(19) United States
(12) Patent Application Publication
(10) Pub. No.: US 2003/0207066 A1
(43) Pub. Date: Nov. 6, 2003

(54) Thermally printed ticket structure

(75) Inventor: Edward J. Killey, Green Bay, WI (US)

Correspondence Address: Mathew E. Corr, BOYLE, FREDRICKSON, NEWHOLM, STEIN & GRATZ, S.C., 250 Plaza, Suite 1030, 250 East Wisconsin Avenue, Milwaukee, WI, 53202, US

(73) Assignee: Green Bay Packaging, Inc.

(21) Appl. No.: 10/427,261

(22) Filed: May 1, 2003

Related U.S. Application Data
(60) Provisional application No. 60/377,555, filed on May 3, 2002.

(51) Int. Cl. B32B 31/00

(52) U.S. Cl. 428/42.1; 156/277; 156/289; 156/252

(57) ABSTRACT

A multi-ply ticket structure having a thin film layer adhered differentially to an underlying film or paper-based base layer, which supports a thermally-imagable coating between the thin film layer and the base layer. Specified areas of the overlying film are selectively removable, and may include vision-blocking opaque materials thereon, while adjacent areas of the film remain permanently bonded to the base layer. The film layer is of sufficient thinness to allow thermal energy from a thermal printer to penetrate the film layer and any adhesive used to attach the film layer to the base layer and cause imaging of the thermal coating atop the base layer. The differential bonding of the film layer to the base layer allows the specified area of the film layer including the opaque material to be removed after imaging to expose the variably-imprinted indicia on the thermal coating while the permanently bonded areas of film layer provide tamper-resistance protection of other imprinted indicia, such as a bar code or other security features.

### CROSS REFERENCE TO RELATED APPLICATIONS

This application claims priority from U.S. Provisional Patent Application Serial No. 60/377,555, which was filed on May 3, 2002.

### FIELD OF THE INVENTION

The present invention relates to thermally printed materials and more particularly to thermally printed tickets used for gaming, special promotions or coupons wherein thermally printed data is digitally created on the tickets by a thermal printer connected to a controller in an on-demand fashion as opposed to pre-printing entire lots or batches of tickets.

### BACKGROUND OF THE INVENTION

Gaming tickets of the “pull-tab” or “scratch-off” type enjoy widespread popularity by permitting the purchaser of the ticket to possess and play at will a game-piece of chance formed by or on the ticket. The drawback to these types of tickets for a lottery or random chance gaming is that all of the tickets must be printed with winning or losing criteria in advance of the distribution and sale of the tickets. Therefore, these tickets require high levels of security to be present in all phases of the manufacture, delivery, storage and disbursement of the gaming tickets. The cost of providing the security for the production and distribution of the tickets greatly increases the per ticket production cost.

With the use of computer-driven thermal printers, separate portions of a stock material may be printed on-demand for a customer at the site where the printed stock is to be sold. The use of thermally imaged coatings on specified base materials is well known throughout the tag, label and ticket manufacturing arenas. These coated materials, which can be paper-based or plastic films, have self-contained imaging and developing chemistries and need only heat to form a latent image on the stock. No ink or print ribbon is required in the printing engine thereby making the thermal imaging of this type of material at a retail site very convenient. However, the use of this technology in the gaming ticket industry has heretofore not been used due to the construction of prior art thermal print stock materials.

For example, U.S. Pat. No. 6,329,318 to McFall et al. discloses a lamination and method for forming an information displaying label. This patent illustrates how to image a thermally reactive coating under a thin polyester film positioned over the coating to protect the coating both before and after an image is formed on the coating. The polyester film is permanently attached over the coating by the adhesive at all points on the label, which prevents any part of the film from being removed from the label. The construction disclosed in the McFall et al. patent also makes it difficult to form high-resolution graphics of the type desired for information-bearing materials such as tags and gaming tickets. For example, the 48 gauge polyester film combined with the amount of adhesive disclosed in the McFall et al patent to adhere the film to the substrate results in a construction that requires thermal printers to be set at their highest heat-settings in order to form an image on the thermally responsive coating. The running of these types of printers at such a setting causes premature failure of the printer by overheating the delicate print elements inside the printhead. Thus, replication of the label disclosed in the McFall et al. patent results in a label with printed information that is pale in image, and barcodes with very low contrast measurements. Additionally, to obtain the best image the printer must be run at its slowest print speed.

Finally, the McFall et al. patent does not mention or otherwise disclose the need or use of a silicone or wax or similar lubricious coating on the upper surface of the polyester film opposite the substrate. In practice, the use of thermally imaged materials is designed for direct thermal printing machines. The use of an uncoated protective polyester film that comes into contact with the printhead during imaging would cause the polyester film to soften, stick to and ultimately damage the printing elements.

As a result, it is desirable to develop a thermally printable stock that includes a protective film selectively adhered over a thermally reactive coating to allow the stock to function as an on-demand gaming ticket.

### SUMMARY OF THE INVENTION

It is an object of the present invention to provide a laminate structure including a thin polymeric protective film that can be selectively adhered to a substrate over a direct thermal imaging material.

It is another object of the present invention to provide a laminate structure in which the thin polymeric film includes score lines that increase the ease of removal of selected removable portions of the film that adjoin non-removable portions.

It is still another object of the present invention to provide a laminate structure including a lubricious coating that allows the structure to be thermally printed in order for the laminate structure to function as a gaming ticket.

It is still a further object of the present invention to provide a laminate structure that can be thermally printed on demand at a retail outlet by a suitable controller connected to a thermal printer in order to negate the security concerns normally associated with gaming tickets.

The present invention is a laminate structure including a polymeric film of sufficient thinness laminated to a substrate and holding a direct thermal imaging material between the film and the substrate. The total thickness of the film and the adhesive layer used to join the film to the imaging surface of the substrate is designed to maximize the ability of conventional thermal printing machines to transmit heat through the film to the thermal imaging material to form a high resolution image in the material.

The utility of the construction as a gaming ticket may be further enhanced by permanently bonding specified areas of the film to the substrate adjacent areas of the film which are removable from the substrate. The permanently bonded areas directly contact the adhesive, while the removable areas have a release coating disposed beneath both the film and the adhesive. Also, the thin polymeric film can be coated totally or partially on one side with an opaque material to render any underlying imaged or printed material or symbology that is formed under the open material completely obscured until the film is removed.

The laminate construction of the present invention allows the construction to be utilized for thermal printers utilized to print gaming tickets at retail locations. The printers can be connected to a network controller that operates to specifically indicate which type or number of images are to be printed on the particular gaming ticket as it is printed at the retail location. Thus, the need for various security measures heretofore used with prior art gaming tickets is eliminated. This is because the design of this laminate structure provides the controller with a means to encode important data such as serial numbers or images such as bar codes on a blank ticket to ensure the validity of the ticket while also enabling the controller and printer to create imbedded images or messages for players on the ticket so they have a sense of interaction with the gaming ticket. The removal of the removable sections of the thin film reveals the interactive portion of the ticket, and the permanently bonded area of the film covers the validation data printed on the ticket.

Various other features, objects and advantages of the invention will be made apparent from the following detailed description taken together with the drawings.

### BRIEF DESCRIPTION OF THE DRAWINGS

The drawings illustrate the best mode currently contemplated of practicing the present invention.

In the drawings:

FIG. 1 is an isometric view of the components of the laminate structure of the present invention; and

FIG. 2 is an exploded view of the laminate structure of FIG. 1.

### DETAILED DESCRIPTION OF THE INVENTION

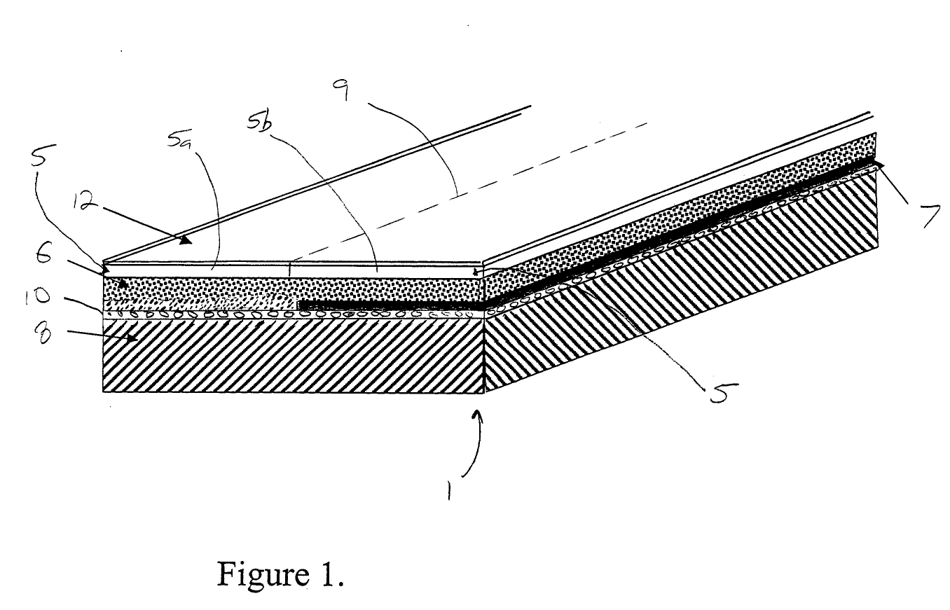

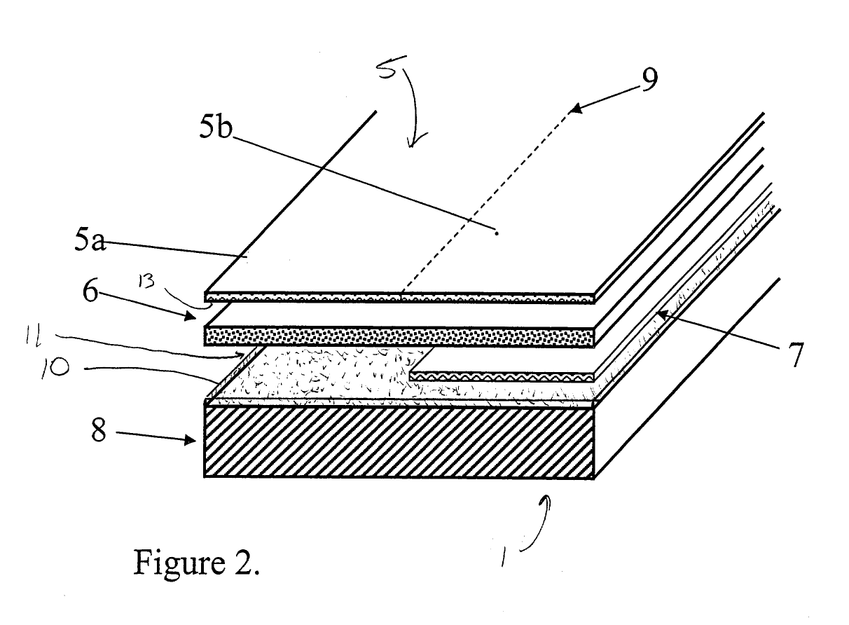

With reference now to the drawing figures in which like reference numerals designate like parts throughout the disclosure, a laminate structure indicated generally at 1 is shown in FIGS. 1 and 2. The laminate structure 1 is formed of a substrate 8 that supports a release coating 7 along selected sections of the substrate 8, and a pressure sensitive adhesive 6 laminated over the sections of the coating 7 and the substrate 8. The adhesive 6 can be any suitable adhesive, with a water-containing adhesive emulsion being particularly preferred. A thin polymeric film 5 is laminated over the adhesive 6 opposite the substrate 8 to enclose the adhesive 6 between the film 5 and substrate 8.

The substrate 8 can be any suitable type of film or paper compatible with thermal imaging chemistry, and is selected based on its caliper or stiffness in order to best suit the feel of a gaming ticket or the like. Representatively, a tag stock known as Royale 700 obtained from Appleton Papers in Appleton, Wis., was selected. This tag material is 4.5 mils (0.0045″) thick and includes a direct thermal imaging material 10 applied to one side. The direct thermal imaging material 10 is a material that comes into direct contact with a thermal printhead in conventional thermal printers (not shown), such as those manufactured and sold by Zebra, Sato and Intermec, and forms an image representative of the contact made by the printhead on the material 10.

The polymeric film 5 is chosen for its thinness and thermal stability. To this end, in the preferred embodiment the film 5 is a polyester film having a thickness of 24 gauge or one-quarter mil (0.00025″). This particular film may be obtained from numerous producers such as du Pont, Toray, SKC and Mitsubishi Films. Thinner polyester films may also be used but the handling characteristics become difficult for the producer of the structure 1 and the player who would wish to remove the film 5 from the substrate 8. Further, slightly thicker films 5 may be used, but the images formed on the direct thermal imaging material 10 become less resolved and requires the printers to be set at their highest heat settings. In a preferred embodiment, the side of the film 5 adjacent the adhesive 6 can have an opaque material 13 placed thereon. In a particularly preferred embodiment, the opaque material 13 is a layer of vaporized aluminum sprayed onto the film 5 to form a layer that is on the order of 107 to 120 angstroms in thickness in order to metallize and obscure the entire film 5 or selected portions of the film 5 as desired. The vaporized aluminum has an optical density of about 1.8 to 2.0, such that any underlying printed material on the imaging material 10 is completely obscured until the film 5 and opaque material 13 are removed. Further, based on the extreme thinness of the opaque material 13, use of the material 13 does not appreciably increase the thickness of the structure. The opaque material 13 may be applied in a striped fashion, in which alternating transparent and opaque areas are applied to the surface of film 5. This construction facilitates validation when laminate structure 1 is used as a gaming ticket.

The production of the structure 1 begins with application of the release coating 7 to the substrate 8 over selected portions of the thermal imaging material 10 that allows pressure sensitive and non-pressure sensitive adhesives to be removed cleanly with very little peeling forces required. Such a coating 7 can be any suitable non-heat curing material, but typically is a silicone formulation and is preferably one composed of ultra-violet (UV) curing materials. The UV materials do not need heat to cure as opposed to most other silicone releasing chemistries. This is important as the coating 7 is applied to the substrate 8 over the thermal imaging material 10 and sources of heat must be eliminated or reduced to prevent premature imaging of the material 10.

A preferred UV/silicone coating 7 is available through Rhodia or General Electric. The UV/silicone coating 7 is applied to the substrate 8 via a conventional offset-gravure process whereby the coating 7 is metered by the gravure cylinder (not shown) and transferred to a rubber roller (not shown) in contact with the imaging material 10. The rubber roller in turn applies the metered release coating 7 to the surface of the imaging material 10. In a preferred embodiment the rubber roller has a pattern (not shown) engraved upon it that applies the silicone in parallel, continuous bands that run in the machine-direction. This direction is considered to be the running length of substrate 8 as opposed to the width or transverse direction of the substrate 8. Adjacent to the bands of the release coating 7 are areas 11 absent of the release coating 7. These areas 11 run parallel to the release coating 7 along the entire length of the substrate 8. After the release coating 7 is applied to the desired areas of the substrate 8, the entire substrate 8 passes through a UV-curing chamber (not shown) that causes the coating 7 to solidify without pre-imaging the thermal imaging material 10 on the substrate 8. However, other patterns for the application of the release coating 7 on the substrate 8 can also be used. For example, when the entire side of the film 5 is covered with the opaque material 13 to obscure all printed material formed on the imaging material 10, the release coating 7 is applied over the entire exposed surface of the imaging material on the substrate 8.

The substrate 8 and the cured release coating 7 are then coated with a pressure sensitive adhesive 6 across the entire substrate 8 with both the release coating 7 and the uncoated areas 11 of the substrate 8 being simultaneously covered with the adhesive 6. The adhesive 6 is preferably high in tack and is deposited at a rate of three (3) to five (5) pounds per 3,000 square feet. Typical water-containing adhesive emulsions may be obtained from companies such as Rohm & Haas and Ashland Chemical. The adhesive coated substrate 8 is passed through a hot air drier (not shown) after the application of the adhesive 6 to remove the water carrier in the adhesive 6. The drying temperatures are maintained at low enough levels to remove the water from the adhesive 6 but not to heat the substrate 8 up to the point of causing the thermal imaging material 10 to react and turn dark.

Upon exiting the drying oven, the thin film 5 is laminated across the entire surface of the exposed adhesive 6. The film 5 is oriented on the adhesive 6 such that any portions of the film 5 that are coated with the opaque material 13 are aligned with and/or positioned over the release coating 7, while the clear sections of the film 5 are positioned over uncoated areas 11 of the film 5. Thinner films may also be used but the lamination sequence becomes increasingly difficult, and thinner films of polyester also tend to have a higher raw material cost as their manufacture is difficult and slower compared to thicker gauges of polymeric films. The completed laminate structure I is then wound in roll form in a continuous fashion as is known in the art. The roll of the laminate structure 1 is subsequently slit in the previously defined machine direction into narrower rolls for conversion into the printed and die-cut segments that will become the gaming tickets or the like.

Opaque material 13 is applied to the desired area of film 5 adjacent adhesive 6 using any satisfactory application equipment, by a metallizer available such as Vacumet Corp., although it is understood that other satisfactory metallizers may be employed. Opaque material 13 may be applied in full coverage, or may be applied in a striped fashion as noted previously in which opaque material 13 is applied in stripes running in the machine direction, with a clear area between adjacent stripe areas.

The conversion of the laminate structure 1 may include printing on the upper surface of the polyester film 5 in a conventional manner with inks and/or varnishes. Further, a final coating 12 may be applied over the film 5 opposite the adhesive emulsion 6, such as a wax or silicone, to permit the ticket to pass through a thermal printer without the film 5 causing abrasive damage to the printhead mechanism.

In order to effectively separate those portions of the film 5 disposed over the strips of release coating 7, and preferably including the opaque material 13, from those positioned over the uncoated areas 11, the film 5 can include a slit or perforation 9 extending along the film 5 in the machine direction, thereby forming separate pieces of film 5a and 5b. Each piece 5a of film 5 that overlies a non-release-coated area 11 of the substrate 8 is permanently attached to the laminate structure 1. The adjacent film piece 5b with the opaque material 13 covers the release coating 7 and is releasably fixed to the structure 1 and may be removed, taking the adhesive 6 with it. The slit 9 can completely separate the respective pieces 5a and 5b of the film 5, or may form a perforation that keeps the pieces 5a and 5b in alignment with one another and prevents inadvertent or premature removal of the removable piece 5b. However, in those situations where the entire film 5 is covered with the opaque material 13 and is to be removed, the slit 9 is omitted.

After the structure 1 has been converted into the form of a ticket, the roll of the substrate 8 including the release coating 7, adhesive 6, and polymeric film 5, can be distributed to various retail outlets for use with vending machines (not shown) that include thermal printing devices. The roll of the substrate 8 can be positioned within each machine, such that the structure 1 is dispensed through the thermal printer which, in turn, is connected to a network by a controller which determines what type or number of indicia are to be printed on the ticket by the thermal printer. The indicia printed on the ticket can include the game indicators, any decorative indicia to be positioned around the game indicators and various security features. The security features are printed beneath the permanently attached film piece 5a and can include a bar code, a serial number, or a certification symbol, among others. Therefore, when a customer wishes to purchase one or more tickets, the retailer can operate the machine to thermally print a number of tickets in an on-demand fashion in the manner specified by the controller connected to the machine.

While the preferred embodiment of the present invention is discussed above, other variations to the invention are contemplated as falling within the scope of the present invention. More specifically, the release coating 7 can also be applied to the substrate 8 in a manner which provides for a number of separate removable film locations on the substrate 8, such as a number of geometric windows which can be separately removed from the ticket, with each window being obscured by a section of the film 5b to which is applied the opaque material 13.

Various alternative embodiments are contemplated as being within the scope of the following claims which particularly point out and distinctly claim the subject matter regarded as the invention.

I claim:

1. A lamination for use as a gaming ticket comprising:
a) a substrate including a direct thermal imaging material disposed on one side of the substrate;
b) a release coating applied to at least one portion of the substrate over the direct thermal imaging material;
c) an adhesive applied over the substrate and the release coating; and
d) a polymeric film disposed on the adhesive layer opposite the substrate, the polymeric film including at least one separable area that overlies the release coating.

2. The lamination of claim 1 wherein the polymeric film is formed from a polyester film.

3. The lamination of claim 2 wherein the polymeric film has a maximum thickness of 24 gauge.

4. The lamination of claim 1 wherein the polymeric film includes an outwardly facing, slippage-inducing coating disposed on the film opposite the adhesive layer.

5. The lamination of claim 1 wherein the adhesive is a water-containing emulsion.

6. The lamination of claim 1 wherein the release coating is a UV curable coating.

7. The lamination of claim 1 wherein the release coating is applied in at least one band extending along a longitudinal direction of the substrate.

8. The lamination of claim 1 further comprising an opaque material on at least one section of the film adjacent the adhesive.

9. The lamination of claim 8 wherein the opaque material is positioned in alignment with the release coating.

10. The lamination of claim 8 wherein the opaque material is applied in spaced apart locations so as to provide alternating transparent and opaque areas.

11. The lamination of claim 8 wherein the opaque material is vaporized aluminum.

12. The lamination of claim 1 wherein the at least one separable area is defined by at least one slit formed in the film.

13. A process for forming a laminate including the steps of:
a) providing a substrate including a direct thermal imaging material on one side of the substrate;
b) applying a release coating to at least one portion of the substrate over the direct thermal imaging material;
c) applying an adhesive over the substrate and the release coating; and
d) applying a polymeric film over the adhesive.

14. The method of claim 13 wherein the release coating is a UV release coating and further comprising the step of curing the release coating after applying the release coating to the substrate.

15. The method of claim 13 further comprising the step of forming a slit in the polymeric film and the adhesive, wherein the slit is oriented so as to form a separable area of the polymeric film that overlies the release coating.

16. The method of claim 15 wherein the step of forming the slit comprises forming a perforation in the polymeric film.

17. The method of claim 13 further comprising the step of drying the adhesive after applying the adhesive to the substrate and release coating.

18. The method of claim 13 further comprising the step of applying an opaque material to at least one section of the film prior to applying the film over the adhesive.

19. The method of claim 18 wherein the step of applying the film over the adhesive comprises:
a) aligning the at least one section of the film with the opaque material with the at least one portion of the substrate with the release coating; and
b) engaging the polymeric film with the adhesive.

20. The method of claim 18 wherein the step of applying the opaque material comprises metallizing the at least one section of the film.

21. A method for printing a gaming ticket comprising the steps of:
a) providing a laminate including a substrate having a direct thermal imaging material disposed on one side of the substrate, a release coating applied to at least one portion of the substrate over the direct thermal imaging material, an adhesive applied over the substrate and the release coating, and a film disposed on the adhesive layer opposite the substrate, the film including at least one separable area that overlies the release coating; and
b) forming printed material on the direct thermal imaging material.

22. The method of claim 21 wherein the laminate includes an opaque material on at least one section of the film adjacent the adhesive and in alignment with the release coating, and wherein the step of forming the printed material comprises forming the printed material on the direct thermal imaging material directly beneath the opaque material.

23. The method of claim 22 further comprising the step of forming additional printed material on the direct thermal imaging material apart from the opaque material.
